(19) United States
(12) Patent Application Publication
(10) Pub. No.: US 2007/0192777 A1
(43) Pub. Date: Aug. 16, 2007

(54) Optical disk apparatus

(76) Inventors: Sojiro Kirihara, Kawasaki (JP); Shinya Tsubota, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/496,582

(22) Filed: Aug. 1, 2006

(30) Foreign Application Priority Data
Feb. 15, 2006 (JP) 2006-037637

(51) Int. Cl. G11B 7/00

(52) U.S. Cl. 720/674

(57) ABSTRACT

Within an optical disk apparatus of slot-in type, having a traversing mechanism portion 5, which mounts a disk motor 2, a turntable 2a and an optical pickup 3, etc., thereon, being attached on a chassis 4 building up a housing of the apparatus, and also an elevating mechanism for brining an optical disk to be chucked on the turntable when loading it, there is further provided height adjusting mechanisms or members 200a and 200b are provided at two (2) positions on a supporting axis line of the traversing mechanism and the position coming off that, thereby making the traversing mechanism adjustable with respect to the chassis, when the apparatus performs recording/reproducing operation thereon. Therefore, there is provided the optical disk apparatus, generating no abnormal sound due to contact of the optical disk with a part of housing of the apparatus when it is in the position for recording/reproducing operation, in spite of thinning in the thickness of the housing of the apparatus.

### BACKGROUND OF THE INVENTION

The present invention relates to an optical disk apparatus for recording or reproducing information onto/from a disc-like optical recording medium, such as, CD or DVD, etc., (hereinafter, being called by an “optical disk”), for example, and in particular, it relates to the structures of the optical disk apparatus of so-called a slot-in type, wherein a turntable moves elevating when the optical disk is loaded therein.

Optical disk apparatuses for recording or reproducing information, utilizing the optical disk to be the recording medium thereof, are widely used as an information recording apparatus or device, within various electronic apparatuses, such as, a personal computer or the like, for example. With such the disk apparatuses, conventionally, many of them adopt such a loading method, in which the disk is first mounted on a tray or a turntable and then is loaded into an inside of the main body of the apparatus.

On the other hand, within the fields of a personal computer of notebook type and/or a car navigation apparatus, etc., in particular, requirements are made remarkably, upon the optical disk apparatus of being thin in the thickness thereof, due to the fact that a space for installation thereof is restricted into a very narrow place accompanying with small-sizing thereof; however, such loading method as mentioned above has a limit in reducing the thickness of the disk apparatus, as a whole, because of necessity of the tray and the turntable thereof.

Then, as was already known in the following Patent Documents 1 and 2, for example, there is proposed a method of drawing the disk therein, while abutting a transmission roller on the disk surface (i.e., the slot-in method), and are also proposed various improvements for achieving the thinning and small-sizing of the disk apparatus, as a whole thereof.

[Patent Document 1] Japanese Patent Laying-Open No. Hei 7-220353 (1995); and

[Patent Document 2] Japanese Patent Laying-Open No. 2002-352498 (2002).

### BRIEF SUMMARY OF THE INVENTION

By the way, within such optical disk apparatus of slot-in type as was mentioned above, a member of so-called traversing mechanism, including a turntable, etc., is elevated up and down in the position thereof, within a narrow clearance in an inside of the apparatus, so as to chuck the optical disk when loading it therein, and thereafter the said traversing mechanism is turned back to a predetermined position parallel to a case, thereby to carry out recording/reproducing operation onto/from the optical disk. However, when conducting this recording/reproducing operation, in particular, within the optical disk apparatus of super- or ultra-thin type having an outer configuration of height (i.e., thickness), about 9.5 mm, since a gap (or, clearance) is also restricted, very much, between the optical disk and a housing of the apparatus (i.e., the case), then the optical disk abuts or contacts on a case surface due to an increase of movement in the vertical direction on an outer periphery thereof, in particular, such as, CD or DVD, etc., being relatively large in the radius thereof, in case when the traversing mechanism is inclined with respect to the upper and lower surfaces of the case (i.e., the housing) building up the apparatus. For that reason, the said apparatus brings about drawbacks that it generates abnormal sounds due to the contact of the disk, and depending on the cases, that it injures or damages the information recording surface of the optical disk, etc. However, none of the conventional arts mentioned above takes such the problems into the consideration thereof.

Then, according to the present invention, achieved by taking such the problems mentioned above into the consideration thereof, an object thereof is to provide an improved optical disk apparatus of slot-in type, chucking the optical disk drawn therein through elevating position of the traversing mechanism, wherein a portion of the optical does not contact with the housing thereof, at the position for recording/reproducing operation of the traversing mechanism, in spite of reduction in thickness of the housing of the apparatus.

According to the present invention, for accomplishing the object mentioned above, firstly there is provided an optical disk apparatus, comprising: a chassis, which builds up a housing of the apparatus; a traversing mechanism, which includes at least disk motor, a turntable, and an optical pickup therein, and is attached on said chassis, in rotatable manner; an elevating mechanism which moves said traversing mechanism up and down so as to chuck an optical disk onto said turntable when loading it therein; and an inclination adjusting mechanism which adjusts an inclination of said traversing mechanism with respect to said chassis when said optical disk apparatus performs recording or reproducing operation.

Further, according to the present invention, within the optical disk apparatus as described in the above, it is preferable that said inclination adjusting mechanism is made of a height adjusting member with using a screw therein, and further that said height adjusting member is provided coming off a supporting axis line of said traversing mechanism, which is attached in rotatable manner.

Further, according to the present invention, within the optical disk apparatus as described in the above, it is also preferable that said height adjusting member is formed with said elevating mechanism into one body, that said height adjusting member is provided neighboring to an end portion of said traversing mechanism, together with said elevating mechanism, and further that said elevating mechanism is made up with a cam, which forms a cam surface o n a column-shaped outer periphery thereof, and said height adjusting member is made up with portion of a member for supporting said cam rotatable with respect to said chassis.

Also, according to the present invention, within the optical disk apparatus as described in the above, it is preferable that another height adjusting member for building up said inclination adjusting mechanism is further provided at one end portion on said supporting axis line of said traversing mechanism portion, or that other height adjusting members for building up said inclination adjusting mechanism are further provided both end portions on said supporting axis line on said traversing mechanism portion, and further that said height adjusting member provided at one end portion on said supporting axis line is a screw, which screwed into a penetrating hole formed on a member for supporting one end portion rotatable on said supporting axis line of said traversing mechanism portion, or that into said light receiving means said height adjusting members provided at both end portions on said supporting axis line are screws, which are screwed into penetrating holes formed on a member for supporting both end portions rotatable on said supporting axis line of said traversing mechanism portion. In addition thereto, it is preferable that said supporting member or each of said supporting members is made of an elastic material.

Further, according to the present invention, within the optical disk apparatus as described in the above, the housing of said apparatus is about 9.5 mm in thickness thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a perspective view for showing the entire structures of an optical disk apparatus, removing a top cover thereof, according to an embodiment of the present invention;

FIGS. 2(a) and 2(b) are a partial enlarged perspective view and a plane view, for showing portion “A” magnified within FIG. 1 mentioned above;

FIGS. 3(a) to 3(c) are cross-section views for explaining the operations of a cam mechanism, in particular, of an elevating mechanism portion within the optical disk apparatus shown in FIG. 1 mentioned above;

FIG. 4 is a plane view for showing the condition of the apparatus, before operations of the cam mechanism of the elevating mechanism portion within the optical disk apparatus shown in FIG. 1 mentioned above;

FIG. 5 is a plane view for showing the condition of the apparatus, but after the operations of the cam mechanism of the elevating mechanism portion within the optical disk apparatus shown in FIG. 1 mentioned above;

FIG. 6 is a rear view of a housing of the apparatus (i.e., a case) for showing an arrangement of an inclination adjustment mechanism (i.e., a height adjusting mechanism) within the configuration of the optical disk apparatus, according to the present invention; and

FIGS. 7(a) and 7(b) are partial enlarged views of the inclination adjustment mechanism (i.e., the height adjusting mechanism), including the cross-sections thereof, for showing the detailed structures thereof.

### DETAILED DESCRIPTION OF THE INVENTION

Hereinafter, embodiments according to the present invention will be fully explained by referring to the attached drawings.

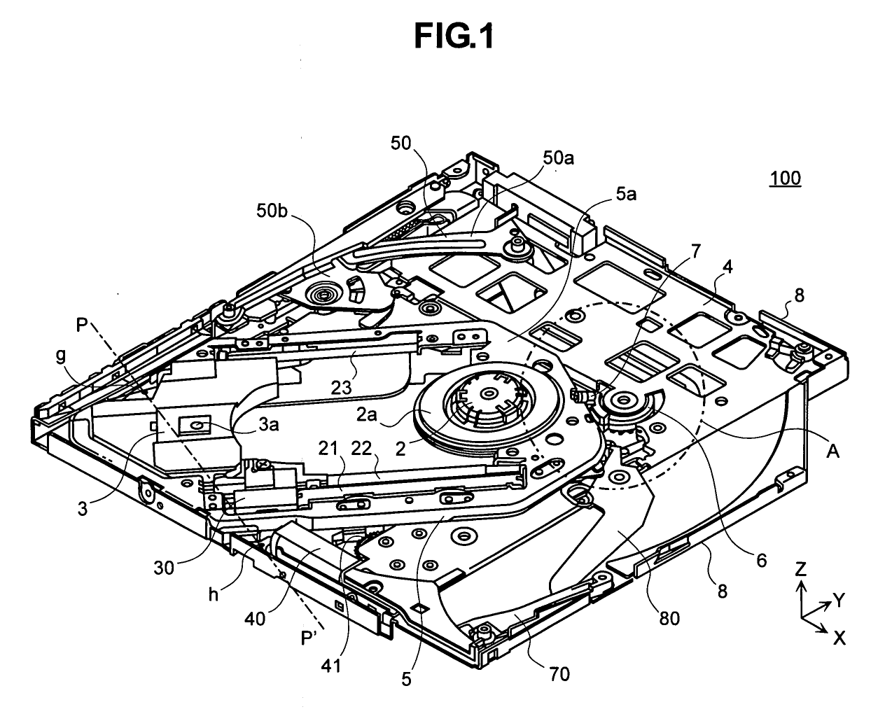

First of all, FIG. 1 attached herewith is a perspective view for showing the structures of an optical disk, according to an embodiment of the present invention, being viewed from a front side (i.e., a disk loading side) thereof. In this FIG. 1, a reference numeral 100 depicts an optical disk apparatus, comprising a disk motor 2, for rotationally driving an optical disk, though not shown in the figure, a turntable 2a for mounting the optical disk thereon, having a tip cover also not shown in this figure, an optical pickup 3, an objective lens 3a of the optical pickup, a chassis 4 as a first basement of the apparatus, and so-called a traversing mechanism portion 5, being made up with the disk motor 2, the turntable 2a and the optical pickup 3, including therein, for chucking the optical disk thereon through the elevating movement when loading it therein, so as to conduct recording/reproducing operation thereon.

However, this traversing mechanism portion 5 comprises a traversing mechanism deck portion 5a, as a supporting base thereof, i.e., to be a second basement, being rotatable/movable around a supporting point or fulcrum to the chassis 4 mentioned above. In more details thereof, the traversing mechanism deck portion 5a has a pair of rotation fulcrums “g” and “h”, and it can rotate around a straight line (hereinafter, a support axial line) “P-P′” passing through those rotation fulcrums “g” and “h”, thereby elevating up and down. Also, a reference numeral 6 in the figure depicts a cam mechanism for rotating or moving the traversing mechanism deck portion 5a around the fulcrums, thereby elevating the position thereof to the chassis 4, and a reference numeral 7 depicts a cam pin, which is provided at an end portion (e.g., the left-hand side end in the figure) of the traversing mechanism deck portion 5a, to be engaged with a cam surface of the cam mechanism 6. Further, a reference numeral 8 in the figure depicts a bottom case for covering over a reverse surface side of the optical disk apparatus 100 mentioned above.

Further, on the traversing mechanism portion 5, in particular, on a cylindrical surface thereof is formed a screw groove, and thereby providing so-called a reed screw member 21, for moving the optical pickup 3 mentioned above abound the radial direction of the optical disk loaded due to rotation thereof, and in that instance, the said optical pickup 3 is guided by the guiding members 22 and 23. Further, a reference numeral 30 in the figure depicts a feed motor for rotationally driving the reed screw member 21 mentioned above. And, on this traversing mechanism deck portion 5a, being as the second basement, are also mounted the disk motor 2, the optical pickup 3 and so on, which are mentioned above, as well as, the reed screw member 21, the guiding members 22 and 23, which are also mentioned above.

The optical disk apparatus 100 comprises a loading motor 40 for generating a driving force to move the optical disk into a loading direction or into an unloading direction, and the driving force from the loading motor 40 is transmitted to the side of a load through a transmission gear array 41. Also, within the apparatus is provided an arm member 50 for transmitting the driving force for that loading/unloading (or inserting/discharging) operation, when the optical disk is inserted (or loaded) into the main body of the apparatus from the side of a front panel into the Y-axis direction, or when it is discharged (or unloaded) from an inside of the main body of the apparatus to the side of the front panel. This arm member 50 comprises an arm portion 50a and also an arm supporting portion 50b for supporting that arm portion to be rotatable. Further, a reference numeral 70 depicts a disk slot arm member for drawing the optical disk into the main body of the apparatus, and a reference numeral 80 a sub-lever member.

With such structures of the optical disk apparatus 100 mentioned above, the cam mechanism 6 has the structure of providing a cam groove for defining a cam surface on the outer peripheral portion of a column-like body thereof, and according to the present embodiment, it is provided to be rotatable, directing the rotation shaft thereof into the direction nearly equal to the rotation shaft of the disk motor 2 (i.e., the Z-axis direction), within an orthogonal projection region of the optical disk chucked on the turntable upon the chassis 4 (i.e., a circular region which can be obtained through the orthogonal projection upon a circular plan of the optical disk). Also, on the outer periphery of the cam mechanism 6 is formed a cam groove for defining a cam surface, on the periphery of the rotation shaft, with respect to the direction of said rotation shaft (i.e., the Z-axis direction). On the other hand, the cam pin 7 provided at an end portion of the traversing mechanism deck portion 5a is inserted into the said cam groove, at a tip portion thereof, to be engaged with the cam surface. With this, the cam pin 7 elevates up and down accompanying with rotation of the cam mechanism 6, so as to rotate the traversing mechanism deck portion 5a around the rotation fulcrums “g-h”, i.e., the supporting axis line “P-P′” mentioned above, and thereby makes up an elevating mechanism portion for moving the traversing mechanism deck portion 5a, elevating up and down, with respect to the chassis 4 building up the housing of the apparatus (i.e., the case).

Also, the optical disk apparatus 100 mentioned above is covered with a top cover member not shown in the figure, on the front surface side thereof, and also, the present apparatus defines an optical disk apparatus of super or ultra-thin type, being equal to 9.5 mm or less than that, in the size of thickness thereof (i.e., the distance between the outer surface of the top cover member and the outer surface of the bottom case 8).

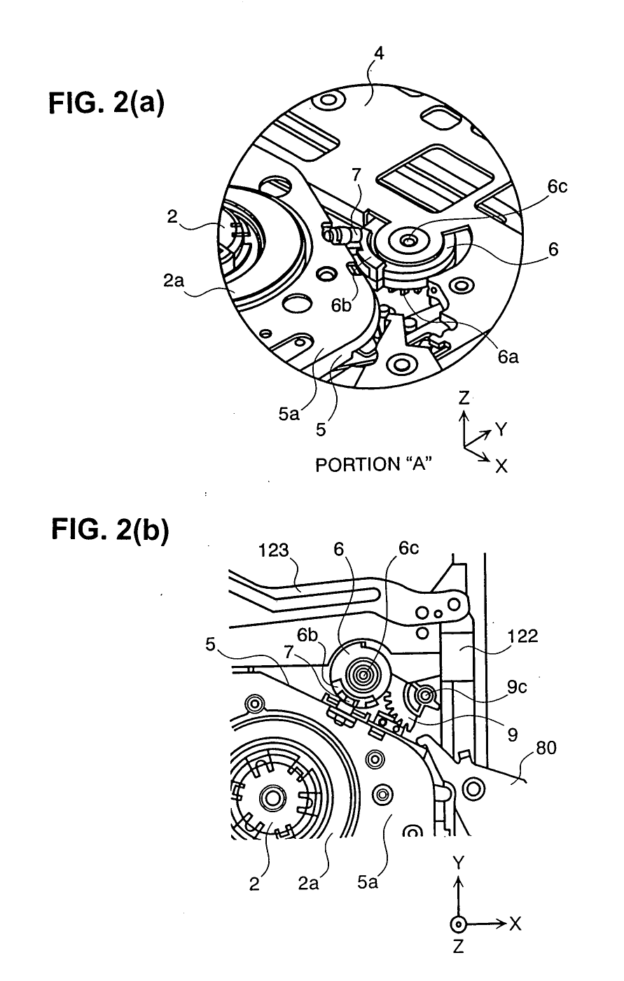

Next, FIGS. 2(a) and 2(b) attached here with are a perspective view for showing the enlarged “A” portion in FIG. 1 mentioned above and a plane view thereof. As apparent from those figures, the cam mechanism 6 has a driven gear 6a, which is provided concentrically, around the rotation shaft 6c thereof, as a portion to be driven, and a cam portion 6b formed with a cam surface (i.e., a groove) on an outer periphery thereof. And, with the driven gear 6a of the cam mechanism 6 mentioned above is engaged with a driver gear 9, and thereby transmitting a driving force for rotating the cam mechanism 6 around the rotation shaft 6c to the driven gear 6a mentioned above. Further, a reference numeral 9c in the figure depicts a rotation shaft of that driver gear 9.

Further, reference numerals 122 and 123 depict so-called lever members, operating when loading or unloading the optical disk. Thus, to those lever members 122 and 123 is transmitted the rotational driving force of the loading motor 40, through the transmission gear array 41 mentioned above, when moving the optical disk into the loading direction or when moving it into the unloading direction, although not shown in the figure, and thereby moving the optical disk within the main body of the apparatus, into such the position that the optical disk can be chucked, or drawing out the optical disk from the position where the chucking can be made, directing into an outside of the main body of the apparatus, while keeping the optical disk under a predetermined condition. And, the cam pin 7 mentioned above is disposed on the side of the traversing mechanism deck portion 5a, on a straight line connecting between a center (i.e., the central axis of rotation) of the rotation shaft 6c of the cam mechanism 6 and a center (i.e., the central axis of rotation) of the disk motor 2.

For example, upon loading the optical disk therein, the loading motor 40 starts the rotation thereof, when the optical disk is inserted into a predetermined position within the main body of the apparatus, and therefore the rotational driving force of the said loading motor 40 is transmitted through the transmission gear array 41 to the lever member 122, and thereby the lever member 122 makes a straight line movement. This rotates the driver gear 9 of the cam driver portion around the rotation shaft 9c thereof. On the other hand, this driver gear 9 drives the driven gear 6a due to the rotation thereof, and thereby rotating the cam mechanism 6 around the rotation shaft 6c. And, due to movement of the cam surface with the rotation of this cam mechanism 6, the cam pin 7 moves the position thereof into the direction of the rotation shaft of the cam mechanism 6, i.e., the Z-axis direction along with the cam surface. Thus, the movement of this cam pin 7 in the Z-axis direction makes the traversing mechanism deck portion 5a rotate on the rotation fulcrums “g” and “h”, i.e., around the supporting axis line “P-P′”, and thereby moving the disk motor 2 and the turntable 2a on that traversing mechanism deck portion 5a, elevating up and down with respect to the chassis 4 mentioned above. And, accompanying with going up of this turntable 2, the turntable 2a is inserted into a central opening of the optical disk, under the condition of pushing it onto an interior surface of the top cover not shown in the figure; i.e., conducting the chucking of the optical disk.

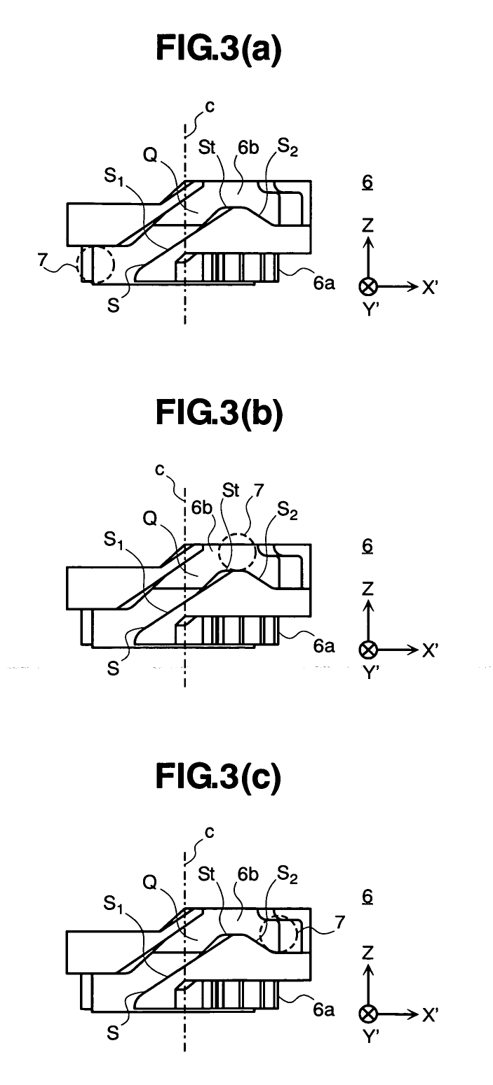

Following to the above, FIGS. 3(a) to 3(c) are views for explaining about the operations of the cam mechanism 6, within the elevating mechanism shown in FIG. 1 and FIGS. 2(a) and 2(b) mentioned above. First, FIG. 3(a) shows the condition where the cam pin 7 does not start the elevating movement into the Z-axis direction by means of the cam mechanism 6, yet, and FIG. 3(b) shows the position of the cam pin 7 on the cam surface, when the optical disk is chucked on the turntable 2a after the cam pin 7 starts the elevating movement into the rotation axis direction (i.e., the Z-axis direction) of the cam mechanism 6 along the cam surface, accompanying with the rotation of the cam mechanism 6 mentioned above. And, FIG. 3(c) shows the position of the cam pin 7 on the cam surface when starting recording or reproducing operation on the optical thereon, after chucking the optical disk.

However, in the figures mentioned above, “c” depicts a rotation center of the cam mechanism 6, “Q” a cam groove of the cam mechanism 6, “S₁” a first cam surface of the cam surfaces on the cam mechanism 6, “S₂” a second cam surface of the same, “Sₜ” a maximum cam surface where a curve of the cam surface reaches to the maximum between the first cam surface “S₁” and the second cam surface “S₂”, respectively. However, other reference numerals or marks are similar to those shown in FIG. 1 and FIGS. 2(a) and 2(b).

And, when chucking, the driver gear 9 rotates into anticlockwise direction, so as to drive the driven gear 6a, and thereby driving the cam mechanism 6 into the clockwise direction around the rotation center “c” of the cam mechanism (=around the rotation axis 6c). With the rotation in the clockwise direction of this cam mechanism 6, the cam surfaces “S₁”, “Sₜ” and “S₂” move to the cam pin 7, sequentially, and therefore the cam pin 7 moves into the Z-axis direction and -Z-axis direction, along the curves of the cam surfaces “S₁”, “Sₜ” and “S₂”. And, when the cam pin 7 abuts on the cam surface “S₁”, after moving from the position shown in FIG. 3(a) due to rotation of the cam mechanism 6, then the cam surface “S₁” brings that cam pin 7 to move up into the Z-axis direction along the curve thereof. Thus, accompanying with such elevating movement of that cam pin 7, also the traversing mechanism deck portion 5a rotates around the rotation fulcrums “g” and “h”, i.e., the supporting axis lien “P-P′”, into the anticlockwise direction, and thereby brining the disk motor 2 and the turntable 2a, and further the optical disk chucked thereon, to move up with respect to the chassis 4 building up the housing (or, the case) of the apparatus. Then, with such the elevating movement, the turntable 2a comes close to the top cover not shown in the figure, while mounting the optical disk thereon.

Thereafter, when the cam pin 7 reaches to the position of the cam surface “Sₜ”, then the cam pin 7 comes up to the highest position in the Z-axis direction (see FIG. 3(b)). Then, at that position, the optical disk on the turntable 2a is pushed onto the interior surface of the top cover, and therefore it is into the condition of being chucked onto the turntable 2a. Thereafter, when the cam mechanism 6 rotates further into the clockwise direction, then the cam pin 7 abuts on the cam surface “S₂”. And, on that cam surface “S₂”, the cam pin 7 is moved, gradually falling down into the -Z-axis direction. Accompanying with such fall-down movement of this cam pin 7, also the traversing mechanism deck portion 5a rotates around the rotation fulcrums “g” and “h”, i.e., the supporting axis lien “P-P′”, into the clockwise direction, and thereby brining the disk motor 2 and the turntable 2a, together with the optical disk chucked thereon, to move falling down with respect to the chassis 4. And, with such the fall-down movement, the optical disk chucked on the turntable 2a separates from the interior surface of the top cover, to be under the rotatable condition, and therefore recording or reproducing can be made there upon (see FIG. 3(c)).

On the other hand, in case when the optical disk is unloaded, the driver gear 9 rotates into the clockwise direction, so as to drive the driven gear 6a, and thereby rotating the cam mechanism 6 into the anticlockwise direction around the rotation center 6c thereof. With doing this, the cam pin 7 abuts on the cam surfaces, in the order of “S₂”, “Sₜ” and “S₁”, so that the cam pin 7 moves the position thereof into the Z-axis direction and -Z-axis direction, along with the curves of the cam surfaces “S₂”, “Sₜ” and “S₁”. With this, the traversing mechanism deck portion 5a is rotated around the supporting axis line “P-P′” to move the turntable 2a up and down, and thereby removing the optical disk from the chucking condition on the turntable 2a, separating it therefrom.

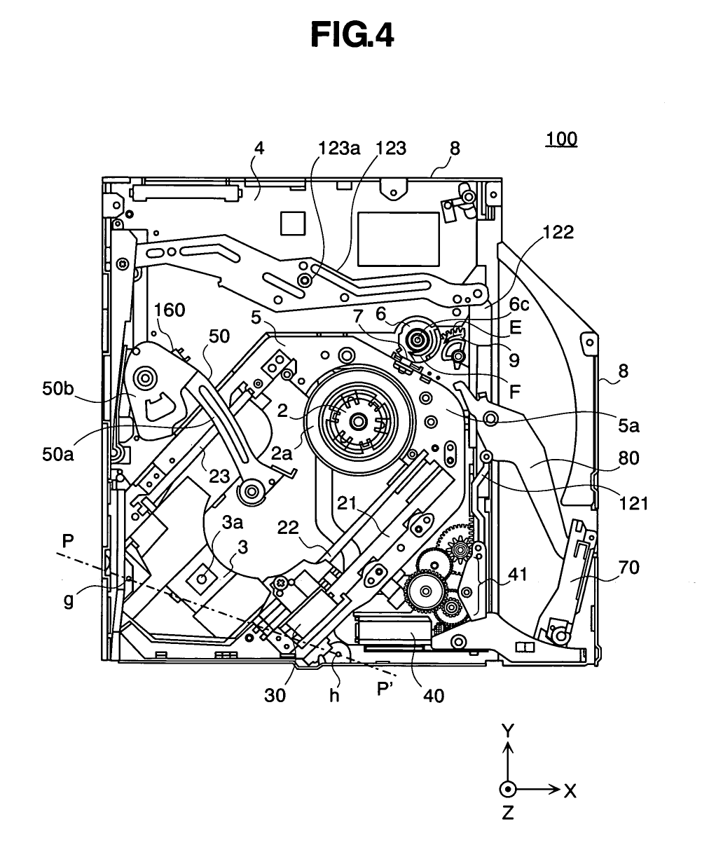

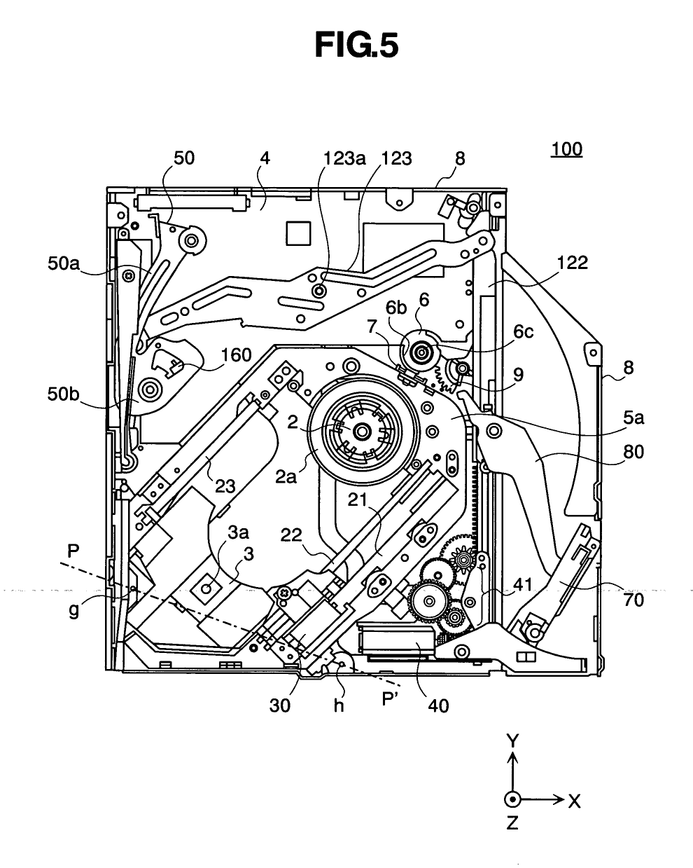

Further, FIG. 4 shows the condition of the apparatus before the cam mechanism of the elevating mechanism portion operates, which is shown in FIG. 1, and FIG. 5 shows the condition of that after the cam mechanism of the elevating mechanism portion operates. In those figures, a reference numeral 160 depicts a switch for turning conduction of electricity ON or OFF to the loading motor 40. But, other reference numeral or marks are similar to those shown in FIG. 1 and FIGS. 2(a) and 2(b). Then, upon loading of the optical disk, when the optical disk is inserted into an inside of the main body of the optical disk apparatus 100 under the condition shown in FIG. 4, the said optical disk is further drawn into the inside of the main body of the apparatus, through functions of the disk slot arm member 70 and the sub-lever member 80, and at the same time, the lever members 122 and 123 operate, so that the arm portion 50a and the arm support portion 50b of the arm member 50 are rotated around the fulcrums thereof. And, when the arm support portion 50b rotates, the switch 160 is pushed down accompanying therewith, and thereby turning the loading motor 40 into ON condition, so as to rotate. As a result thereof, the rotational driving force thereof is transmitted to the lever member 122 through the transmission gear array 41, and further transmitted to the driver gear 9 of the cam driving portion, thereby rotating that driver gear 9 around the rotation shaft 9c thereof.

The driver gear drives the driven gear 6a through the rotation thereof, and thereby rotating the cam mechanism 6 around the rotation shaft 6c thereof. Through movement of the cam surface due to rotation of the cam mechanism 6, the cam pin 7 engaged with the cam groove is moved into the Z-axis direction or the -Z-axis direction along the curves of the cam surfaces. Due to moving of the cam pin 7 on the position thereof into the Z-axis direction or the -Z-axis direction, the traversing mechanism deck portion 5a rotates around the rotation fulcrums “g”-“h”, i.e., the supporting axis line “P-P′”, so as to move the disk motor 2 and the turntable 2a on that traversing mechanism deck portion 5a, with respect to the chassis 4 mentioned above, thereby chucking the optical disk on the turntable 2a. In this instance, the optical disk apparatus 100 is in the condition shown in FIG. 5, wherein an output signal of that switch 160 is inputted into a microcomputer or the like, not shown in the figure, as a control means of the optical disk apparatus 100, on the other hand, upon basis of controls signals from that microcomputer or the like, control is made on driving of the loading motor 40, etc.

As was mentioned above, within the optical disk apparatus 100 of the slot-in method of drawing the optical disk into while abutting a transmission roller on the surface thereof, in particular, within the traversing mechanism portion 5 for chucking the optical disk through elevating the position up and down when loading, under the condition of recording or reproducing operation shown in FIG. 3(c) mentioned above, the traversing mechanism deck portion 5a is moved to be in parallel with the chassis 4, and thereby rotationally driving the optical disk chucked on the turntable 2a, which is provided on that traversing mechanism deck portion 5a.

However, in this instance, within the optical disk of super- or ultra-thin type, in particular, having an outer configuration of the apparatus, being of about 9.5 mm in height (i.e., thickness), as was mentioned above, the distance (i.e., the clearance) is restricted very much, between the optical disk and the housing (or, the case) of the apparatus, in particular, between the top cover (i.e., the upper surface) and the chassis 4 (i.e., the lower surface) in this case. For this reason, in the case where this traversing mechanism 5, i.e., the traversing mechanism deck portion 5a is inclined with respect to the chassis 4, which builds up the housing (or, the case), then the optical disk, such as, CD or DVD, for example, being relatively large in the radius thereof, abuts or contact on the top cover (i.e., the upper surface) or the chassis 4 (i.e., the lower surface) at the outer periphery thereof. For this reason is brought about the problem that the abnormal sounds is generated due to the contact of the disk, and/or that the optical disk is injured or damaged on the information recording surface thereof. However, as is apparent from the structures mentioned above, this inclination of the traversing mechanism 5 is caused due to and determined by the pair of the rotation fulcrums “g” and “h” (i.e., the supporting axis line “P-P′”) of the traversing mechanism deck portion 5a, and further the cam mechanism 6 for elevating up and down that traversing mechanism deck portion 5a with respect to the chassis 4, in particular, the position of the cam pin 7 engaged with the cam surface thereof.

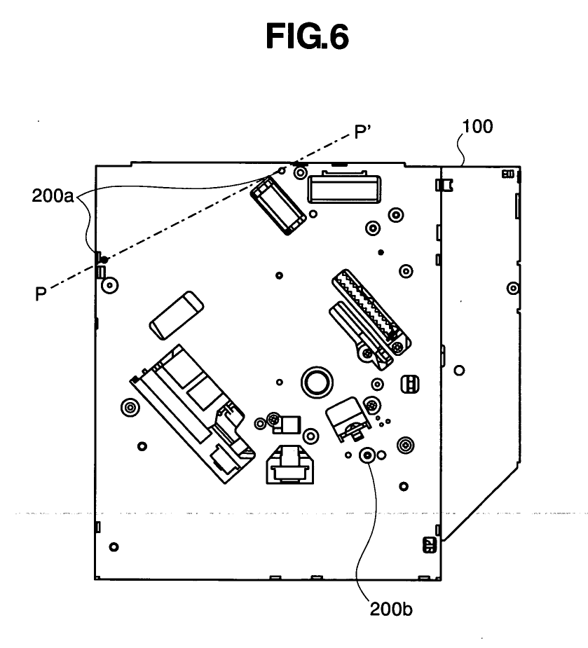

Then, according to the present invention, so as to dissolve such the problem, the inclination and/or the height of the traversing mechanism 5 is made adjustable when the apparatus is in recording/reproducing operation, so as to enable the optical disk to take a parallel position within the housing (or, the case) of the apparatus when it is in recording/reproducing operation, and there is further provided an inclination adjusting mechanism for enabling a manual adjustment of the inclination when the apparatus is in recording/reproducing operation. In more details, as is apparent from FIG. 6 attached herewith, for showing the rear surface of the housing (or, the case) of the optical disk apparatus, height adjusting mechanisms or members 200a and 200b are provided at three (3) points, including the pair of the rotation fulcrums “g” and “h” of the traversing mechanism deck portion 5a, and the cam mechanism 6 for determining the position of the cam pin 7. However, in the present embodiment, there is shown an example of applying, such as, so-called screw means, as those height-adjusting mechanisms.

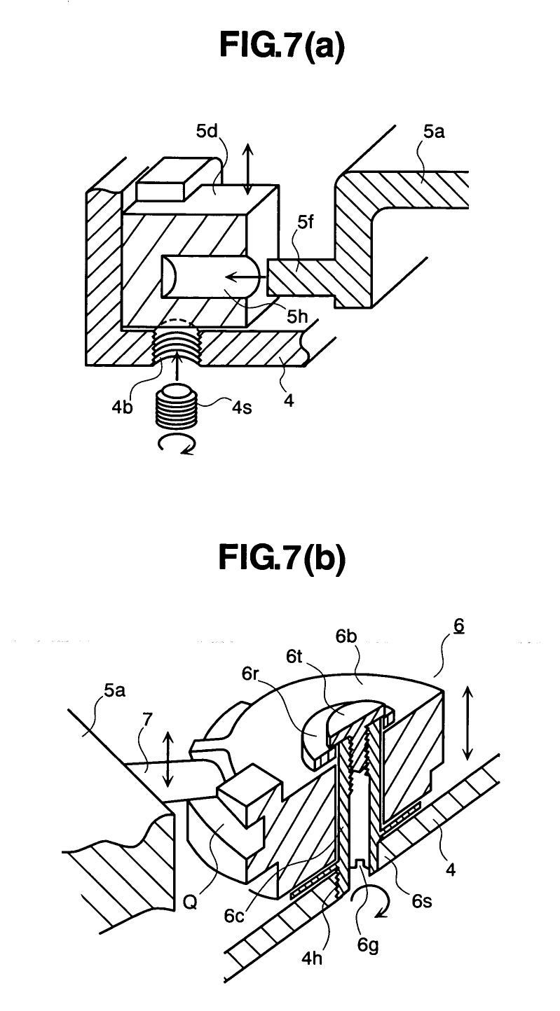

FIGS. 7(a) and 7(b) attached herewith show the detailed structures of the height adjusting mechanisms or members 200a and 200b mentioned above, and firstly FIG. 7(a) shows the detailed structures of each of the adjusting mechanisms or members 200a, which are provided along the supporting axis line “P-P′”, i.e., at the positions of the rotation fulcrums “g” and “h” of the traversing mechanism deck portion 5a. Further, as apparent from the figure, on both ends of the traversing mechanism deck portion 5a along with the supporting axis line “P-P′” are provided projecting leg portions 5f, respectively, and on the other hand, on an interior wall surface of the chassis 4 building up the housing (or, the case) of the optical disk apparatus is attached a dumber 5d, being made of elastic material, such as a rubber, etc., for example, at a predetermined position (i.e., at the position indicated by a reference numeral 200a in FIG. 6 mentioned above). On the other hand, on a bottom surface of this chassis 4 is formed a penetrating hole 4b, on an inner peripheral surface thereof being cut with thread grooves, at the position of the lower surface of the damper 5d. Further, a position adjusting screw 4s is provided for achieving the position adjustment, being screwed into that penetrating hole 4b.

And in such the structures mentioned above, a tip of the leg portion 5f of the traversing mechanism deck portion 5a is inserted into an insertion hole 5h, which is formed on a side surface of the damper 5d, and therefore the traversing mechanism deck portion 5a can rotate around the supporting axis line “P-P′” mentioned above. Thus, the traversing mechanism 5, which is made up with the disk motor 2 and the turntable 2a attached on that rotatable traversing mechanism deck portion 5a mentioned above, can move the position thereof up and down with respect to the chassis 4 building up the housing (or the case) of the apparatus, when loading the optical disk into the apparatus, so as to chuck the optical disk on the turntable 2a, and also thereafter can move to the recording/reproducing position. And, this traversing mechanism deck portion 5a is adjustable up and down at the height thereof, because the damper 5d is pushed upwards accompanying with rotation of the position adjusting screw 4s provided screwing into that penetrating hole 4b (please see an arrow in the figure).

Also, FIG. 7(b) shows an example of the height adjusting mechanism or member 200b, which is provided at the position out of the supporting axis line “P-P′” mentioned above. In more details, it shows the height adjusting mechanism for making adjustment of the height with respect to the chassis 4, which is provided in one body with the cam mechanism 6, for receiving the cam pin 7 provided at the end of the traversing mechanism deck portion 5a into a groove “Q” on the cam portion 6b thereof, and for elevating the traversing mechanism deck portion 5a up and down accompanying with the rotation thereof.

Thus, as is shown in the figure, with this height adjusting mechanism or member 200b, in a lower end portion of the rotation shaft 6c for supporting the cam portion 6b of the cam mechanism 6 rotatable around the periphery thereof, there are formed thread grooves 6s, and also grooves 6g at the lower end thereof, into which a tip of a screwdriver can be inserted, for example. On the other hand, on an inner peripheral surface of a through hole 4h formed on the bottom surface of the chassis 4. Further, as is apparent from this figure, this rotation shaft 6c is hollow in an inside thereof and is provided with a flange portion on an outer periphery of lower portion thereof. Moreover, on an inner peripheral surface in upper portion thereof are formed thread grooves. Also, a reference numeral “6t” in the figure depicts a screw, which is screwed on an upper end of the rotation shaft 6c, and a reference numeral “6d” a ring member.

Thus, with this, the cam portion 6b of the cam mechanism 6 mentioned above is attached, but rotatable around the rotation shaft 6c. And, with rotation of this rotation shaft 6c, inserting the screwdriver or the like into the grooves 6g provided on the lower end surface thereof, it is possible to adjust the position of the cam portion 6b of the cam mechanism 6 up and down (please see an arrow in the figure). And, with doing this, the traversing mechanism deck portion 5a, inserting the cam pin 7 thereof into the groove “Q” formed on the outer peripheral surface of that cam portion 6b, is also adjustable in the position thereof up and down (please see an arrow in the figure).

However, the adjustment in height of the traversing mechanism 5 with respect to the chassis 4, with using the height adjusting mechanisms or members 200a and 200b, the detailed structures of which are explained in the above, it is executed by adjusting the screws at three (3) points, including the pair of the rotation fulcrums “g” and “h” of the traversing mechanism deck portion 5a and the cam mechanism 6 for determining the position of the cam pin 7, upon a result of measurement of the height of the traversing mechanism, such as, through a laser displacement gauge, etc., for example, after assembling the optical disk apparatus. Further, thereafter, confirmation is made on whether abnormal sounds are generated or not due to the contact of the disk, while conducting recording/reproducing operation on a disk into the optical disk apparatus, which is prepared in advance for use of checking, by taking unintentional movement or fluctuation upon the surface of the optical disk into the consideration thereof. As a result, if there is any problem, adjustment is made, again, by rotating the screws mentioned above. However, with the height to be adjusted actually, it is sufficient to be very small amount, such as, 0.2-0.3 mm, for example, in particular, with the optical disk apparatus of super- or ultra-thin type, having the height (i.e., the thickness) of about 9.5 mm, in an outer configuration thereof.

Also, mentioning was made on the structures of providing the height adjusting mechanisms at three (3) points, for adjusting the inclination of the traversing mechanism deck portion 5a with respect to the chassis 4, in the example mentioned above; i.e., as a mechanism for adjusting the traversing mechanism 5 in case when conducting recording/reproducing on the optical disk after chucking thereof, in particular, for maintaining the optical disk chucked to be parallel within the optical disk apparatus. However, the present invention should not be restricted only to that, but in the place thereof, for example, the height adjusting mechanism or member 200b may be provide at the position coming off the supporting axis line “P-P′” mentioned above, i.e., only at the position of the cam mechanism 6. Or, alternately, with provision of only one of the pair of height adjusting mechanisms, which would be provided along the supporting axis line “P-P′”, but together with the adjusting mechanism or member 200b at the position of the cam mechanism 6, it is also possible to adjust the inclination of the traversing mechanism, i.e., the traversing mechanism deck portion 5a with respect to the chassis 4 building up the housing (or, the case) of the apparatus, in the similar manner to the above, and thereby, there can be obtained the effects similar to those mentioned above.

As apparent from the above, according to the present invention, within the optical disk apparatus of the slot-in type, it is possible to make adjustment upon inclination and/or height of the traversing mechanism, moving up and down together with the turntable upon loading operation of the optical disk therein, in particular, when the apparatus conducts recording/reproducing operation, and therefore it is possible to maintain a clearance between the optical disk and the housing, even such the optical disk apparatus of super- or ultra-thin type, being about 9.5 mm in thickness of the housing thereof. As a result thereof, there can be obtained superior effect that it is possible to protect the optical disk from injure or damage on the recording surface thereof, and that no abnormal sound is generated due to the contact of the disk.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An optical disk apparatus, comprising:
a chassis, which builds up a housing of the apparatus;
a traversing mechanism, which includes at least disk motor, a turntable, and an optical pickup therein, and is attached on said chassis, in rotatable manner;
an elevating mechanism which moves said traversing mechanism up and down so as to chuck an optical disk onto said turntable when loading it therein; and
an inclination adjusting mechanism which adjusts an inclination of said traversing mechanism with respect to said chassis when said optical disk apparatus performs recording or reproducing operation.

2. The optical disk apparatus, as described in the claim 1, wherein said inclination adjusting mechanism is made of a height adjusting member with using a screw therein.

3. The optical disk apparatus, as described in the claim 2, wherein said height adjusting member is provided coming off a supporting axis line of said traversing mechanism, which is attached in rotatable manner.

4. The optical disk apparatus, as described in the claim 3, wherein said height adjusting member is formed with said elevating mechanism into one body.

5. The optical disk apparatus, as described in the claim 4, wherein said height adjusting member is provided neighboring to an end portion of said traversing mechanism, together with said elevating mechanism.

6. The optical disk apparatus, as described in the claim 4, wherein said elevating mechanism is made up with a cam, which forms a cam surface on a column-shaped outer periphery thereof, and said height adjusting member is made up with portion of a member for supporting said cam rotatable with respect to said chassis.

7. The optical disk apparatus, as described in the claim 3, wherein another height adjusting member for building up said inclination adjusting mechanism is further provided at one end portion on said supporting axis line of said traversing mechanism portion.

8. The optical disk apparatus, as described in the claim 3, wherein other height adjusting members for building up said inclination adjusting mechanism are further provided both end portions on said supporting axis line on said traversing mechanism portion.

9. The optical disk apparatus, as described in the claim 7, wherein said height adjusting member provided at one end portion on said supporting axis line is a screw, which screwed into a penetrating hole formed on a member for supporting one end portion rotatable on said supporting axis line of said traversing mechanism portion.

10. The optical disk apparatus, as described in the claim 8, wherein said height adjusting members provided at both end portions on said supporting axis line are screws, which are screwed into penetrating holes formed on a member for supporting both end portions rotatable on said supporting axis line of said traversing mechanism portion.

11. The optical disk apparatus, as described in the claim 9, wherein said supporting member is made of an elastic material.

12. The optical disk apparatus, as described in the claim 10, wherein each of said supporting members is made of an elastic material.

13. The optical disk apparatus, as described in the claim 1, wherein the housing of said apparatus is about 9.5 mm in thickness thereof.
